(19) United States
(12) Patent Application Publication
(10) Pub. No.: US 2010/0290700 A1
(43) Pub. Date: Nov. 18, 2010

(54) INFORMATION PROCESSING DEVICE AND METHOD, LEARNING DEVICE AND METHOD, PROGRAMS, AND INFORMATION PROCESSING SYSTEM

(76) Inventor: Jun Yokono, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/771,847

(22) Filed: Apr. 30, 2010

(30) Foreign Application Priority Data
May 13, 2009 (JP) P2009-116098

(51) Int. Cl. G06K 9/62

(52) U.S. Cl. 382/159

(57) ABSTRACT

An information processing device including an extraction unit and a detection unit. If both a parameter set extracting features from an image and a classifier performing predetermined classification by using the extracted features are statistically learned in advance, the extraction unit extracts features of a recognition target object from an input image by using the parameter set, and the detection unit performs the predetermined classification by using the classifier, which uses the features extracted by the extraction unit, and, on the basis of the result of the classification, determines whether or not the object is included in the input image.

### BACKGROUND OF THE INVENTION

1. Field of the Invention

The present invention relates to an information processing device and method, a learning device and method, programs, and an information processing system, and in particular to an information processing device and method, a learning device and method, programs, and an information processing system that can easily generate a feature extractor fitted to a recognition target.

2. Description of the Related Art

Techniques for detecting humans in images (referred to below as human detection techniques) have been studied and developed for security purposes and on-board applications (see Papageorgiou, C., M. Oren, and T. Poggio, “A General Framework for Object Detection”, Proceedings of the Sixth International Conference of Computer Vision (ICCV '98), Bombay, India, 555-562, January 1998; K. Mikolajczyk, C. Schmid, and A. Zisserman, “Human Detection Based on a Probabilistic Assembly of Robust Part Detectors”, Proc. ECCV, 1:69.81, 2004; Navneet Dalal and Bill Triggs, “Histograms of Oriented Gradients for Human Detection”, CVPR 2005; B. Wu and R. Nevatia, “Detection of Multiple, Partially Occluded Humans in a Single Image By Bayesian Combination of Edgelet Part Detectors”, In Proc. 10th Int. Conf. Computer Vision, 2005; Payam Sabzmeydani and Greg Mori, “Detecting Pedestrians by Learning Shapelet Features”, CVPR 2007; and S. Munder and D. Gavrila, “An Experimental Study on Pedestrian Classification”, for example).

These human detection techniques extract features of humans from images.

For example, in the human detection techniques disclosed in the above-cited documents “Human Detection Based on a Probabilistic Assembly of Robust Part Detectors”, “Histograms of Oriented Gradients for Human Detection”, “Detection of Multiple, Partially Occluded Humans in a Single Image by Bayesian Combination of Edgelet Part Detectors”, “Detecting Pedestrians by Learning Shapelet Features”, and “An Experimental Study on Pedestrian Classification”, the contour features obtained by extracting edges are employed as important features. In general, in the human detection techniques in these documents, different variations of the contour features are defined as new features and used to detect humans.

For example, in the above-cited document “Human Detection Based on a Probabilistic Assembly of Robust Part Detectors”, contour features in terms of Gaussian derivatives are used to express human body parts. For example, in the above-cited document “Histograms of Oriented Gradients for Human Detection”, contour features are expressed by orientation histograms in small regions including edges. For example, in the above-cited document “Detecting Pedestrians by Learning Shapelet Features”, models obtained through supervised learning of small edge regions and hierarchical supervised learning thereof are used in the learning that uses contour features. For example, in the above-cited document “An Experimental Study on Pedestrian Classification”, global edge templates are used for contour features.

### SUMMARY OF THE INVENTION

The human detection techniques in the past including the techniques disclosed in the above-cited documents “A General Framework for Object Detection”, “Human Detection Based on a Probabilistic Assembly of Robust Part Detectors”, “Histograms of Oriented Gradients for Human Detection”, “Detection of Multiple, Partially Occluded Humans in a Single Image by Bayesian Combination of Edgelet Part Detectors”, “Detecting Pedestrians by Learning Shapelet Features”, and “An Experimental Study on Pedestrian Classification” employ feature extractors prepared by natural persons.

Setting parameters for those feature extractors took a considerable time and effort of natural persons.

Since the accuracy of the feature extractor significantly affects the performance of the statistical learner used in a later stage, the natural persons should tune the parameter settings of the feature extractor depending on the recognition target (human in this case) at the cost of much more time and effort.

To sum it up, a feature extractor fitted to the recognition target should be used to enhance the performance of the human detection technique. To generate such a feature extractor, the parameter settings of the feature extractor should be tuned. In the past, such tuning was manually conducted by natural persons at the cost of a considerable time and effort. It was quite difficult, therefore, to generate a feature extractor fitted to the recognition target; generating such a feature extractor, if possible, would take a considerable time and effort.

It is desirable to facilitate the generation of a feature extractor fitted to the recognition target.

An information processing device according to an embodiment of the present invention includes extracting means and detecting means. If both a parameter set used to extract features of a recognition target object from an input image and a classifier performing predetermined classification by using the features extracted by the extracting means have been statistically learned in advance, the extracting means extracts the features of the recognition target object from the image and the detecting means performs the classification by using the classifier, which uses the features and, on the basis of the result of the classification, determines whether or not the object is included in the input image.

The features are obtained through a convolution operation. The parameter set is the filter set used for the convolution operation.

The classifier is a weak discriminator (weak learner) in the statistical learning based on a Boosting algorithm.

The weak discriminator and the parameter set are obtained through self-organizing learning using images including the recognition target object which are given as training samples.

An evolutionary algorithm is employed as a learning algorithm using the training samples.

An information processing method and a first program according to another embodiment of the present invention are the method and program for the information processing device according to the embodiment described above.

In the information processing device and method and the first program according to this embodiment of the present invention, if both a parameter set used to extract features of a recognition target object from an image and a classifier performing predetermined classification by using the extracted features have been statistically learned by the information processing device or a computer recognizing the recognition target object in the image, features are extracted from an input image by using the parameter set, classification is performed by using the classifier, which uses the extracted features, and, on the basis of the result of the classification, the input image is checked for the presence or absence of the object.

A learning device according to still another embodiment of the present invention statistically learns both a parameter set used to extract features of the recognition target object from an image and a classifier performing predetermined classification by using the features.

The features are obtained through a convolution operation. The parameter set is the filter set used for the convolution operation.

The classifier is a weak discriminator (weak learner) in the statistical learning based on the Boosting algorithm.

The learning device receives input images including the recognition target object as training samples and self-organizingly learns the weak discriminator and the parameter set by using the training samples.

An evolutionary algorithm is employed as the learning algorithm using the training samples.

A learning method and a second program according to yet another embodiment of the present invention are the method and program for the learning device according to the embodiment described above.

In the learning device and method and the second program according to this embodiment, both the parameter set used to extract the features of the recognition target object from an image and the classifier performing predetermined classification by using these features are statistically learned.

An information processing system according to yet another embodiment of the present invention includes a learning device and an information processing device. The learning device statistically learns both a parameter set used to extract features of the recognition target object from an image and a classifier performing predetermined classification by using these features. The information processing device extracts the features from the input image by using the parameter set learned by the learning device, performs classification by using the classifier, learned by the learning device, which uses the extracted features, and, on the basis of the result of the classification, determines whether or not the object is included in the input image.

In the information processing system according to this embodiment, the learning device statistically learns both a parameter set used to extract features of the recognition target object from an image and a classifier performing predetermined classification by using these features. The parameter set learned by the learning device is used to extract the features from the input image, the extracted features are used by the classifier learned by the learning device to perform classification, and the result of the classification is used to determine whether or not the object is included in the input image.

According to the embodiments of the present invention, a feature extractor fitted to the recognition target can be easily generated.

### BRIEF DESCRIPTION OF THE DRAWINGS

FIG. 1 is a functional block diagram showing an exemplary functional configuration of a human detection system as the information processing system according to an embodiment of the present invention;

FIG. 2 is a flowchart illustrating an exemplary recognition process performed by the recognition device in FIG. 1;

FIG. 3 illustrates exemplary filters;

FIG. 4 illustrates an exemplary convolution operation, in which the filters in FIG. 3 are used, and an exemplary score calculation;

FIG. 5 is a functional block diagram showing an exemplary functional configuration of the learning device in FIG. 1;

FIG. 6 is a flowchart illustrating an exemplary learning process performed by the learning device in FIG. 1;

FIG. 7 illustrates the first evolutionary algorithm as an exemplary learning algorithm;

FIG. 8 illustrates the second evolutionary algorithm as an exemplary learning algorithm; and

FIG. 9 is a block diagram showing an exemplary hardware configuration of the computer according to an embodiment of the present invention.

### DESCRIPTION OF THE PREFERRED EMBODIMENTS

An information processing system according to an embodiment of the present invention will now be described with reference to the drawings.

### [Exemplary Configuration of Information Processing System]

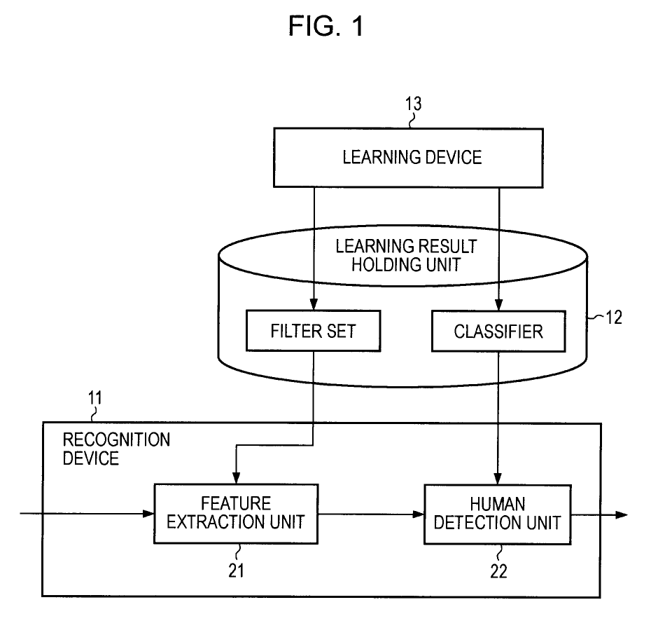

FIG. 1 illustrates an exemplary functional configuration of a human detection system as the information processing system according to an embodiment of the present invention.

Although the target of detection is a human in the example in FIG. 1 for easiness of comparison with typical systems in the past, this is not a limitation; the target may be any entity that is included as an object (projection of any entity in the real world) in an image.

The human detection system in FIG. 1 includes a recognition device 11, a learning result holding unit 12, and a learning device 13.

### [Exemplary Structure of Recognition Device]

The recognition device 11 includes a feature extraction unit 21 and a human detection unit 22.

### [Exemplary Process Performed by Recognition Device]

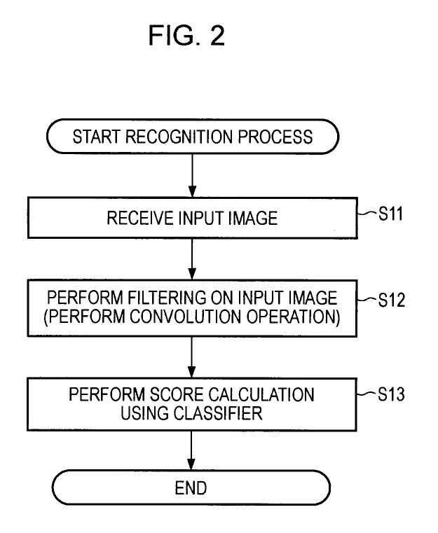

FIG. 2 is a flowchart illustrating an exemplary process performed by the recognition device 11 (referred to below as a recognition process).

In step S11, the feature extraction unit 21 in the recognition device 11 receives an input image.

In step S12, the feature extraction unit 21 performs a filtering operation, in which a filter set is used, on the input image to detect features. The convolution operation mentioned in parentheses will be described later.

It should be emphasized that the filter set, which is equivalent to a set of parameters of a feature extractor, is learned by the learning device 13 in advance, instead of being prepared by a natural person, and is held in the learning result holding unit 12. It should be appreciated that the features extracted by using such a filter set are the features self-organizingly learned by the learning device 13 and fitted to the object (human in the present embodiment) to be recognized by the recognition device 11.

Details of the filtering process and the learning of the filter set will be described later.

In step S13, the human detection unit 22 calculates scores by using the features extracted by the feature extraction unit 21 and a classifier. The human detection unit 22 detects a human from the input image on the basis of the score calculation results. The score calculation will be described later.

Once the process in step S13 is completed, the recognition process is completed.

It should be emphasized here that the classifier is not prepared by a person, but is learned, together with the filter set, by the learning device 13 in advance and is held in the learning result holding unit 12. The classifier generated through such a learning process is fitted to the recognition target (human in the present embodiment) and significantly enhances the detection performance.

### [Exemplary Filtering Process and Score Calculation]

An exemplary filtering process and score calculation will now be described.

For this exemplary score calculation, a discriminator based on a Boosting algorithm is employed.

An AdaBoost algorithm is disclosed in Y. Freund and R. Schapire, “Experiments with a New Boosting Algorithm”, IEEE Int. Conf. On Machine Learning, pp. 148-156, 1996. AdaBoost is a theory that a “strong discriminator” can be constructed by combining many “weak discriminators that perform slightly better than random guessing”. The “weak discriminator that performs slightly better than random guessing” will be referred to below as a weak discriminator. The weak discriminator is also referred to as a weak learner. The “strong discriminator” is also referred to as a strong classifier. This strong discriminator is the discriminator based on the Boosting algorithm.

If the strong discriminator is represented by F(v) and i-th weak discriminator (i is an integer value from 1 to N, N being equal to or greater than 1) is represented by fi(v), the following equation (1) is established:

$$F ( v ) = {\sum }_{i = 1}^{N} {f}_{i} ( v ) \qquad ( 1 )$$

As expressed by equation (1), a strong discriminator F(v) is constructed by combining N weak discriminators f1(v) to fN(v).

In equation (1), v represents a feature vector. The feature vector v is extracted from an image by the feature extractor. In the past, the feature vector v was extracted from an image by a feature extractor constructed with a manually prepared feature set (a parameter set for the feature extractor).

For example, in the above-cited document “A General Framework for Object Detection”, a histogram of oriented gradient (HOG) descriptor is disclosed as a technique for generating a feature vector v. In HOG, the feature vector v is generated on the basis of an edge orientation histogram in a predetermined local region. This feature set (parameter set for a feature extractor) includes many parameters such as the size of a local region, and histogram bin size. Since these parameters significantly affect the performance of the strong discriminator F(v), manually preparing an optimum parameter set (feature set) would take a considerable time and effort.

For example, in the above-cited document “Human Detection Based on a Probabilistic Assembly of Robust Part Detectors”, a Haar feature is disclosed as a technique for generating a feature vector v. The Haar feature is the difference between two regions. The parameters specifying these two regions (sizes and locations of the regions) form a feature set (parameter set for the feature extractor). To prepare an optimum feature set manually, it is necessary to obtain optimum sizes and locations of the regions and would take a considerable time and effort.

In contrast, in the recognition device 11 according to an embodiment of the present invention, a filter set, used as the feature set (parameter set for the feature extractor), is learned by the learning device 13 in advance and held in the learning result holding unit 12.

More specifically, a function G(I) is prepared in advance and is used to extract the feature vector v as expressed by the following equation (2). In equation (2), I is a parameter representing an image.

v=G(I) (2)

For example, the function G(I) is expressed by the following equation (3):

G(I)={I=K,x,y,s} (3)

In equation (3), the right-hand side is a predetermined arithmetic expression including parameters K, x, y, and s. Parameter K represents an n×n convolution filter kernel to be applied to the image I. Parameters x and y represent pixel point coordinates (x, y) in the image I. Parameter s represents a pyramid level in case the image I is a multi-scale image.

For example, the feature vi input into the i-th weak discriminator fi(v) is calculated by a convolution operation (product-sum operation), in which a convolution filter kernel Ki of the function Gi is used as in the following equation (4):

vi=Ki [symbol] imgi (4)

In equation (4), imgi represents a pixel group (block image) at the pixel point coordinates (x, y) of the function Gi in the image to be recognized. The number of pixel groups (block size) depends on the pyramid level s of the function Gi.

Such a convolution operation (product-sum operation) expressed by equation (4) is carried out in the filtering process performed by the feature extraction unit 21 in step S12 in FIG. 2. Since the function Gi is a filter and the set of parameters Ki, xi, yi, and si of the function Gi is a filter set (filter coefficient), the function Gi will be referred to below as the filter Gi as appropriate. The filter set including filters G1 to GN is learned by the learning device 13 and held in the learning result holding unit 12.

As expressed by the following equation (5), the output from the i-th weak discriminator fi(v) is calculated by using the feature vector vi obtained through the convolution operation (filtering process).

fi(v)=ai(vi>thi)+bi (5)

In equation (5), thi represents a predetermined threshold value and ai and bi each represent a predetermined coefficient.

The weak discriminators f1(v) to fN(v) expressed by such an equation (5) are exemplary classifiers. These classifiers (threshold value thi and coefficients ai, bi) are learned, together with the filter set, by the learning device 13 and held in the learning result holding unit 12. The classifier is an example of a statistical learner based on the Boosting algorithm.

The total sum of the outputs from these weak discriminators f1(v) to fN(v) is the output from the strong discriminator F(v) expressed by equation (1). The output from the strong discriminator F(v) is the result of the score calculation by the human detection unit 22 in step S13. More specifically, the score calculation is carried out by calculating the outputs from the weak discriminators f1(v) to fN(v) according to the equation (5) described above and totaling the results of these calculations.

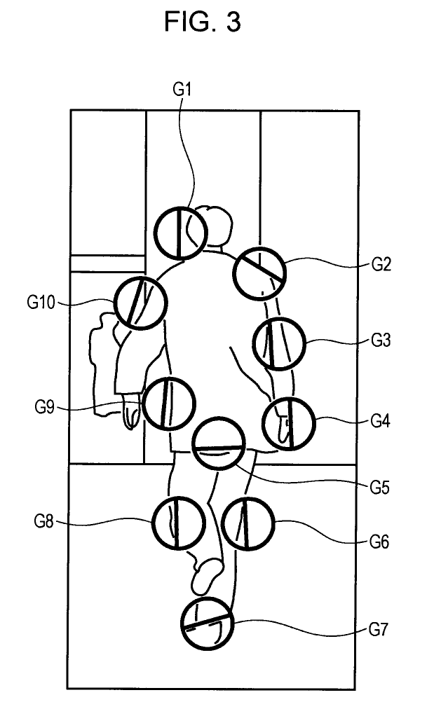

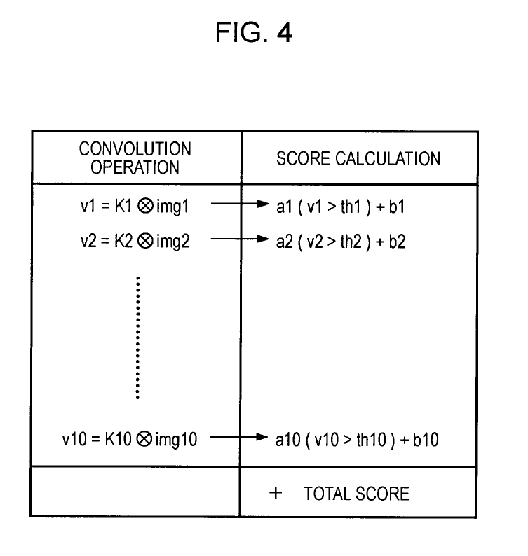

Referring to FIGS. 3 and 4, exemplary convolution operation (filtering process) and score calculation will now be described more specifically.

FIG. 3 illustrates exemplary filters Gi.

FIG. 4 illustrates an exemplary convolution operation (filtering process), in which the filters Gi in FIG. 3 is used, and exemplary score calculations.

Suppose that a filter set (filter coefficient) including the filters G1 to G10 (N=10) in FIG. 3 has been learned by the learning device 13 in advance and held in the learning result holding unit 12.

In this case, in step S12 in FIG. 2, feature vectors v1 to v10 are calculated through the convolution operations shown in the left column of the table shown in FIG. 4.

Next, in step S13, score calculations are carried out as shown in the right column of the table in FIG. 4. More specifically, the equation (5) described above is carried out by using the feature vectors v1 to v10 obtained by the convolution operations to obtain the outputs (scores) from the weak discriminators f1(v) to fN(v). The outputs (scores) of the weak discriminators f1(v) to fN(v) are totaled to obtain the output from the strong discriminator F(v). This total score is used to determine whether or not the input image includes humans. With this, the recognition processing is completed.

The recognition device 11 has been described. The learning device 13 will now be described.

### [Exemplary Structure of Learning Device]

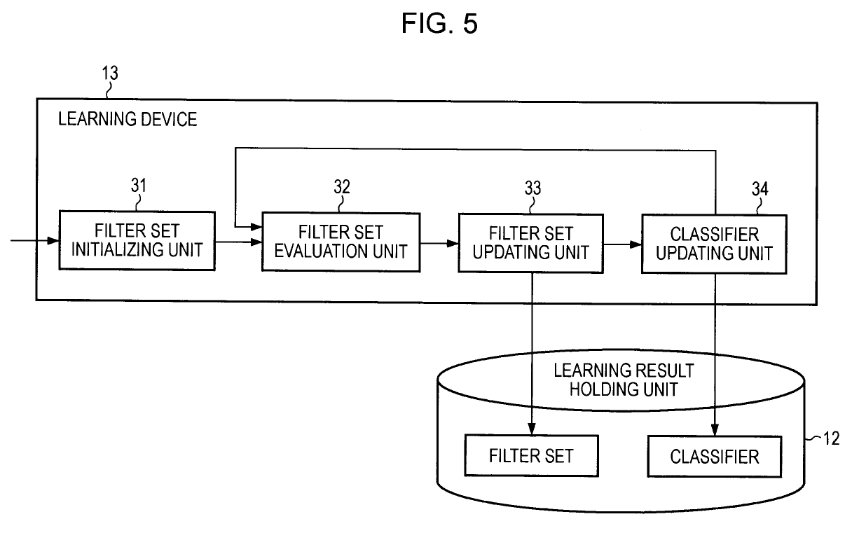

FIG. 5 illustrates an exemplary functional configuration of the learning device 13.

The learning device 13 includes a filter set initializing unit 31, a filter set evaluation unit 32, a filter set updating unit 33, and a classifier updating unit 34.

### [Exemplary Process Performed by Learning Device]

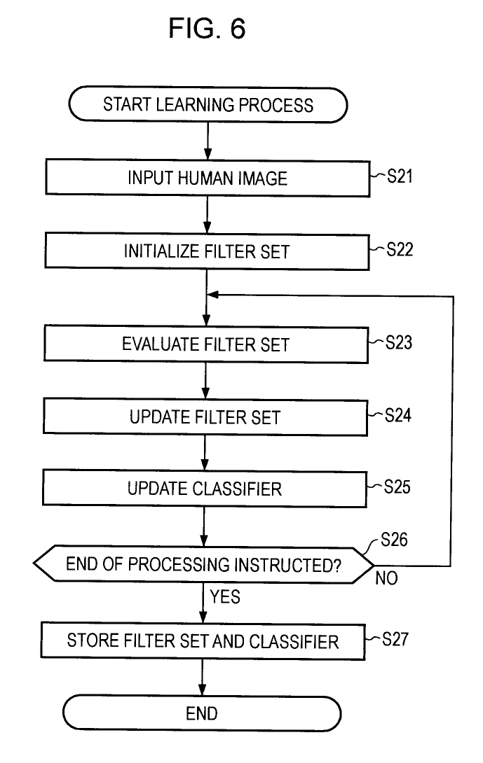

FIG. 6 is a flowchart illustrating an exemplary process performed by the learning device 13 (referred to below as a learning process).

In step S21, the learning device 13 receives an input human image, i.e., an image including a human.

In step S22, the filter set initializing unit 31 in the learning device 13 initializes a filter set.

To initialize the filter set, the filter set initializing unit 31 generates a filter set by setting each parameter of each filter Gi to a random value, for example.

In step S23, the filter set evaluation unit 32 evaluates the filter set.

More specifically, the filter set evaluation unit 32 performs a filtering operation (convolution operation), in which the current filter set is used, on human images, for example. The filter set evaluation unit 32 then assigns the result of the filtering operation (convolution operation) to the current classifier and performs calculation. The filter set evaluation unit 32 then evaluates the current filter set on the basis of the results of this calculation, i.e., on the basis of the classification error of the current classifiers, for example.

The current filter set in step S23 immediately after the processing in step S22 is the filter set initialized in step S22. If NO in step S26, the current filter set in step S23 is the filter set updated in the previous processing in step 24.

The current classifier in step S23 immediately after the processing in step S22 is the predetermined classifier prepared by default. If NO in step S26, the current classifier in step S23 is the classifier updated in the previous processing in step S25.

In step S24, the filter set updating unit 33 updates the filter set on the basis of the evaluation result in step S23. The updated filter set is supplied to the filter set evaluation unit 32 and used as the current filter set in the next processing in step S23.

In step S25, the classifier updating unit 34 updates the classifier on the basis of the evaluation result in step S23. The updated classifier is supplied to the filter set evaluation unit 32 and is used as the current classifier in the next processing in step S23.

In step S26, the learning device 13 determines whether or not the end of processing is instructed.

If the end of processing has not been instructed, the decision in step S26 is NO, so the process returns to step S23 and the processes in step S23 and the subsequent steps are repeated. In this manner, the loop processing from step S23 to S26 is repeated, so the evaluation of the filter set becomes gradually higher. As such a learning process proceeds, the filter set and the classifier are successively updated so that the filter set and the classifier are more fitted to the recognition target (human in the present embodiment).

If the learning is completed and the end of processing is instructed, the decision in step S26 is YES and the process proceeds to step S27.

In step S27, the filter set updating unit 33 and the classifier updating unit 34 store in the learning result holding unit 12 the filter set and classifier that have been fitted through the learning process to the recognition target (human in this embodiment). With this, the learning process is completed.

The filter set and classifier that have been fitted to the recognition target (human in this embodiment) and held in the learning result holding unit 12 are used in the recognition process performed by the recognition device 11 and contribute to enhancing the recognition performance of the recognition device 11.

Such a learning process is automatically performed by the learning device 13. More specifically, a filter set (feature extractor) and a classifier that are fitted to the recognition target are automatically obtained from training samples (human images input in step S21), so manual parameter tuning of the filter set and classifier is eliminated and thereby a considerable time and effort is saved.

An exemplary learning algorithm applicable to this learning process will now be described. An evolutionary algorithm (genetic algorithm) is employed as an exemplary learning algorithm in the following description. The evolutionary algorithm is used to optimize the parameters of the filter set and classifier. For this optimization, classification errors are used as criteria.

### [Exemplary Learning Algorithm]

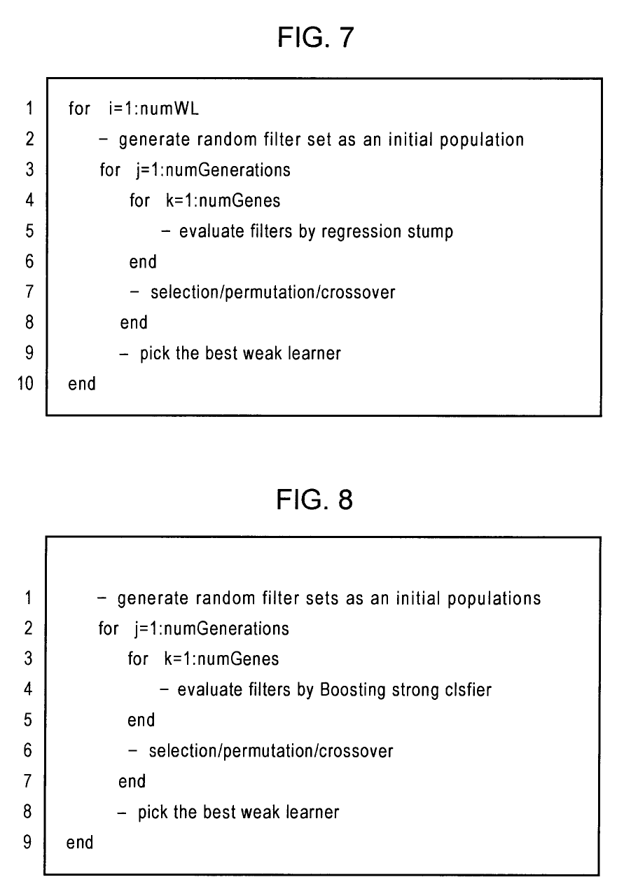

FIG. 7 illustrates an evolutionary algorithm as an exemplary learning algorithm.

In FIG. 7, one of the filters Gi at pixel point coordinates (x, y) in a human image is employed as a gene. The learning algorithm in FIG. 7 will be referred to below as the first evolutionary algorithm.

In FIG. 7, numWL in the first line represents the total number of weak discriminators f(v), i.e., numWL=N in the above embodiment. To obtain the weak discriminators f1(v) to fN(v), the processes in the second through the ninth lines are repeated.

To generate a predetermined number of genes of the first generation (initial candidates for filters Gi), the predetermined number of arbitrary filter sets are generated in the second line in FIG. 7. The process in the second line corresponds to step S22 in FIG. 6.

In FIG. 7, numGenerations in the third line represents the number of the final generation. The processes in the third through the eighth lines are repeated for each generation until the final generation is reached.

In FIG. 7, numGenes in the fourth line represents the total number of genes, which indicates the number of candidates for filters Gi belonging to a certain generation. In the fifth line in FIG. 7, a filter set including a candidate for filter Gi (one gene) is evaluated. More specifically, the processes in the fourth through the sixth lines are repeated to successively evaluate the filter sets for the genes (candidates for filters Gi) belonging to this generation. More specifically, one weak discriminator (classifier candidate) is associated with each gene (each candidate for filter Gi) belonging to a certain generation, so the filter set for a certain gene (one candidate for filter Gi) is evaluated on the basis of the classification error of the weak discriminator (classifier candidate) associated with this gene. In other words, each candidate for filter Gi is evaluated on the basis of a regression stump. The processes in the fourth through the sixth lines correspond to the process in step S23 in FIG. 6.

In the seventh line in FIG. 7, a process for carrying out gene selection, crossover, or mutation according to a predetermined evolution strategy is described. In other words, in the seventh line in FIG. 7, the gene (one candidate for filter Gi) and the weak discriminator associated with this gene are updated. The process in the seventh line corresponds to the processes in steps S24 and S25 in FIG. 6.

Any strategy may be employed as the evolution strategy. For example, a tournament strategy may be employed in which a certain number of individuals (genes) are randomly selected out of a population, among which better fitted individuals are bequeathed. This also applies to the process in the sixth line in FIG. 8 that will be described later.

The operation for bequeathing better fitted individuals is not limited to any particular technique but may employ the following technique, for example.

In this technique, either crossover or mutation is selected depending on the (equal) probability.

If crossover is selected, three individuals (genes) are selected at random, two better fitted individuals are crossed over and replaced with the least fitted individual. For example, the calculation expressed by the following equation (6) is carried out:

P3=P1+α*(P1−P2) (6)

In equation (6), α represents a uniformly distributed random number in the range from −1 to +1. P1 and P2 represent the two better fitted individuals among the three individuals (genes) selected at random. P3 represents the replacement individual.

On the other hand, if mutation is selected, two individuals (genes) are selected at random and the better fitted individual is mutated and replaced with the least fitted individual. For example, the calculation expressed by the following equation (7) is carried out:

P3=P1+d×v (7)

In equation (7), d represents a uniformly distributed random number in the range from −1 to +1. v represents a value equivalent to approximately 5% of the initial search range. P1 represents the better fitted individual of the two individuals (genes) selected at random. P3 represents the replacement individual.

Again, the evolution strategy applicable to the process in the seventh line in FIG. 7 is not limited to the tournament strategy described above, but an elite strategy, for example, may be employed to make sure the best individual is bequeathed to the next generation. This also applies to the process in the sixth line in FIG. 8 that will be described later.

The processes in the third through the eighth lines in FIG. 7 are repeated for each generation until the final generation is reached. The loop processing in the third through the eighth lines that is repeated until the final generation is reached corresponds to the loop processing in steps S23 to S26 in FIG. 6.

Once the processes for the final generation are completed, the process in the ninth line in FIG. 7 is carried out so that the best weak discriminator candidate (classifier candidate) is selected as the final weak discriminator fi(G) (classifier to be held in the learning result holding unit 12). Once the best weak discriminator candidate (classifier candidate) is selected, the gene (candidate for filter Gi) associated with this candidate is also selected. The filter set for this selected gene (candidate for filter Gi) is held in the learning result holding unit 12 as the final filter set for filter Gi. The process in the ninth line in FIG. 7 corresponds to the process in step S27 in FIG. 6. In other words, as a result of the process in the ninth line in FIG. 7, the filter set for filter Gi and the associated weak discriminator fi(G) as the classifier are finally output and held in the learning result holding unit 12.

As described above, the first evolutionary algorithm in FIG. 7 uses a number of filters G corresponding to the number of weak discriminators f(G). For example, if there are a hundred weak discriminators f(G), filters G are learned in a hundred ways.

FIG. 8 illustrates another evolutionary algorithm as an exemplary learning algorithm, which is different from the algorithm in FIG. 7.

In FIG. 8, a chain of filter sets (referred to below as a filter group) of all filters G are employed as genes. The learning algorithm in FIG. 8 will be referred to below as the second evolutionary algorithm.

Described in the first line in FIG. 8 is a process for generating a chain of all filter sets generated at random as initial populations of filter groups. The plural form “filter sets” in the first line in FIG. 8 indicates that all filter sets are chained. The process in the first line corresponds to the process in step S22 in FIG. 6.

The initial populations are not limited to those generated at random as described above. For example, directional filters such as Gabor filters or Gaussian derivative filters may be employed as initial populations.

In FIG. 8, numGenerations in the second line represents the final generation number. The processes in the second through the seventh lines are repeated until the final generation number is reached. The loop processing from the second to the seventh lines that is repeated until the final generation is reached corresponds to the loop processing in steps S23 to S26 in FIG. 6. Except that the genes are different, the processes in the second through the seventh lines in FIG. 8 are basically the same as the processes in the third through the eighth lines in FIG. 7, so description thereof will be omitted.

Once the processes for the final generation are completed, the process in the eighth line in FIG. 8 is carried out so that the best weak discriminator candidate (classifier candidate) is selected as the final weak discriminator fi(G). The process in the eighth line in FIG. 8 corresponds to the process in step S27 in FIG. 6. As a result of the process in the eighth line in FIG. 8, the weak discriminator fi(G) and the associated filter set are finally output and held in the learning result holding unit 12. In the second evolutionary algorithm in FIG. 8, however, each weak discriminator f(G) does not have its own filter set, but a collection of filter sets (a filter group including forty filters G, for example) that is optimal as a whole is output and held in the learning result holding unit 12.

The sequence of processes described above may be carried out by hardware or software. If these processes are carried out by software, a program forming part of this software is installed from a recording medium in which this program is recorded. This program may be installed into a computer embedded in a dedicated hardware, for example. Alternatively, this program may be installed into a general-purpose personal computer, for example, that can execute various functions once various programs are installed.

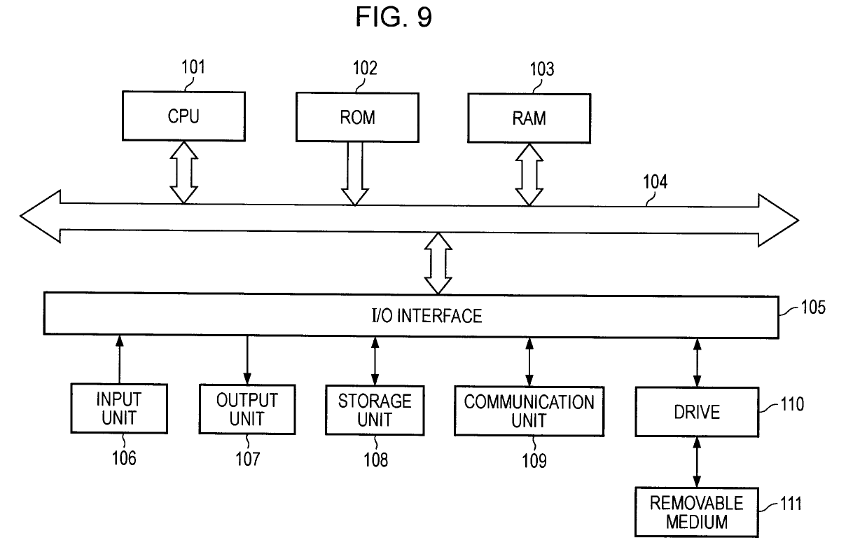

FIG. 9 is a block diagram showing the hardware configuration of a computer that makes a program carry out the sequence of processes described above.

In this computer, CPU 101, ROM (read only memory) 102, and RAM (random access memory) 103 are connected to each other via a bus 104. An I/O interface 105 is also connected to the bus 104. Connected to the I/O interface 105 are an input unit 106 including a keyboard, mouse, and microphone, an output unit 107 including a display and speaker, a storage unit 108 including a hard disk and a nonvolatile memory. Also connected to the I/O interface 105 are a communication unit 109 including a network interface, and a drive 110 for driving a removable medium 111 such as a magnetic disk, optical disk, magneto optical disk, or semiconductor memory.

In the computer thus structured, the CPU 101 loads a program stored in the storage unit 108, for example, via the I/O interface 105 and bus 104 into the RAM 103 and executes this program, so that the sequence of processes described above is carried out. The program executed by the computer (CPU 101) may be provided as recorded in the removable medium 111 that is a magnetic disk (including a flexible disk), for example. The program may be provided as recorded in the removable medium 111 that is a package medium. Examples of the package media include an optical disk (CD-ROM (compact disc-read only memory), DVD (digital versatile disc) etc.), magneto optical disk, or a semiconductor memory. Alternatively, the program may be provided through a wired or wireless transmission medium such as a local area network, Internet, or digital satellite broadcasting. Once the removable medium 111 is mounted on the drive 110, the program can be installed into the storage unit 108 via the I/O interface 105. The program may be received by the communication unit 109 through a wired or wireless transmission medium and installed into the storage unit 108. Alternatively, the program may be installed in the ROM 102 or storage unit 108 in advance.

The program executed by the computer may be a program for executing the processes in a chronological order in the sequence described in this specification, or a program for executing the processes in parallel, or in response to a call, or at appropriate timing.

The present invention is not limited to the embodiments described above, but various modifications and alterations may be made within the scope and spirit of the present invention.

In this specification, the system represents an entire apparatus including a plurality of devices and a processing unit. The information processing system including the recognition device 11, learning result holding unit 12, and learning device 13 may be constructed as a single apparatus.

The present application contains subject matter related to that disclosed in Japanese Priority Patent Application JP 2009-116098 filed in the Japan Patent Office on May 13, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
extracting means for extracting features of a recognition target object from an input image by using a parameter set; and
detecting means for performing a predetermined classification by using a classifier, which uses the features extracted by the extracting means and, on the basis of a result of the classification, determining whether or not the object is included in the input image;
wherein both the parameter set used for extracting the features from the image and the classifier performing the predetermined classification by using the features are statistically learned in advance.

2. The information processing device according to claim 1:
wherein the features are obtained through a convolution operation; and
wherein the parameter set is a filter set used in the convolution operation.

3. The information processing device according to claim 1, wherein the classifier is a weak discriminator, that is, a weak learner, in statistical learning based on a Boosting algorithm.

4. The information processing device according to claim 1, wherein the weak discriminator and the parameter set are obtained through self-organizing learning of images including the recognition target object given as training samples.

5. The information processing device according to claim 4, wherein an evolutionary algorithm is employed as a learning algorithm using the training samples.

6. An information processing method to be performed by an information processing device recognizing a recognition target object in an image, the method comprising the steps of:
extracting features of a recognition target object from an input image by using a parameter set; and
performing a predetermined classification by using a classifier, which uses the extracted features, and, on the basis of a result of the classification, determining whether or not the object is included in the input image;
wherein both the parameter set used for extracting the features from the image and the classifier performing the predetermined classification by using the features are statistically learned in advance.

7. A program for causing a computer controlling recognition of a recognition target object in an image to perform a control process, the process comprising the steps of:
extracting features of a recognition target object from an input image by using a parameter set; and
performing a predetermined classification by using a classifier, which uses the extracted features, and, on the basis of a result of the classification, determining whether or not the object is included in the input image;
wherein both the parameter set used for extracting the features from the image and the classifier performing the predetermined classification by using the features are statistically learned in advance.

8. A learning device statistically learning both a parameter set used to extract features of a recognition target object from an image and a classifier performing a predetermined classification by using the features.

9. The learning device according to claim 8:
wherein the features are obtained through a convolution operation; and
wherein the parameter set is a filter set used in the convolution operation.

10. The learning device according to claim 8, wherein the classifier is a weak discriminator, that is, a weak learner, in the statistical learning based on a Boosting algorithm.

11. The learning device according to claim 8:
wherein images including the recognition target object are input as training samples; and
wherein the weak discriminator and the parameter set are self-organizingly learned by using the training samples.

12. The learning device according to claim 11, wherein an evolutionary algorithm is employed as a learning algorithm using the training samples.

13. A learning method performed by a learning device, the method comprising the step of statistically learning both a parameter set used to extract features of a recognition target object from an image and a classifier performing predetermined classification by using the features.

14. A program for causing a computer to perform a control process, the process comprising the step of:
statistically learning both a parameter set used to extract features of a recognition target object from an image and a classifier performing predetermined classification by using the features.

15. An information processing system comprising:
a learning device statistically learning both a parameter set used to extract features of a recognition target object from an image and a classifier performing predetermined classification by using the features; and
an information processing device extracting the features from an input image by using the parameter set learned by the learning device, performing a classification by using the classifier, learned by the learning device, which uses the extracted features, and, on the basis of the result of the classification, determining whether or not the object is included in the image.

16. An information processing device comprising:
an extraction unit extracting features of a recognition target object from an input image by using a parameter set; and
a detection unit performing a predetermined classification by using a classifier, which uses the features extracted by the extraction unit, and, on the basis of a result of the classification, determining whether or not the object is included in the input image;
wherein both the parameter set used for extracting the features from the image and the classifier performing the predetermined classification by using the features are statistically learned in advance.
